(19) United States
(12) Patent Application Publication
(10) Pub. No.: US 2004/0211298 A1
(43) Pub. Date: Oct. 28, 2004

(54) Shock absorber system adjustment device

(76) Inventor: Donald Edward Williams SR., Dublin, OH (US)

Correspondence Address: DINSMORE & SHOHL LLP, One Dayton Centre, One South Main Street, Suite 500, Dayton, OH, 45402-2023, US

(21) Appl. No.: 10/821,493

(22) Filed: Apr. 9, 2004

Related U.S. Application Data
(60) Provisional application No. 60/461,373, filed on Apr. 10, 2003.

(51) Int. Cl. B25B 13/00

(52) U.S. Cl. 81/58

(57) ABSTRACT

A device for adjusting a shock absorber system. The device includes a handle with a head, where the head defines an engaging member and a ratcheting mechanism cooperative with the engaging member. The engaging member can be coupled to a shock absorber adjustment nut that forms part of the shock absorber system so that upon rotation of the device, the nut is either tightened or loosened. An optional adapter ring can be placed between the engaging member and the shock absorber adjustment nut to allow the device to similarly rotate conventional nuts. The device may further include a hinge between the handle and head to allow the device to fit in tight spaces. In one embodiment, the device may further include a shock absorber adjustment nut that can be used in place of the shock absorber adjustment nut that forms part of the shock absorber system.

This application claims the benefit of U.S. Provisional Application No. 60/461,373 filed Apr. 10, 2003.

### BACKGROUND OF THE INVENTION

The present invention relates generally to a device for turning a threaded nut, and more particularly to a device for adjusting automotive shock absorber systems with adjustable coil spring mountings.

In a typical automotive shock absorber system, the upper end of the shock absorber is secured to the vehicle's frame or chassis and the lower end is secured to a wheel control arm or related part of the vehicle's suspension. In one form, called a coil-over shock arrangement, the system includes a cylindrical shock absorber body having features for the mounting of a resilient coil spring therearound. A piston inside the shock absorber body is connected to a piston rod such that the piston and rod move in response to up or down movement of the wheel relative to the shock absorber body in a telescoping fashion. The coil spring is compressed between seats (also known as spring perches) that are affixed to the piston rod and the shock absorber body, respectively. Together, the spring and shock absorber suspend the vehicle and act to level the vehicle during certain maneuvers, as well as dampen out loads imparted to the vehicle from undulations in the surface upon which the vehicle is riding.

In a typical passenger vehicle application, the shock absorber configuration is either fixed (such that the ride height and relative stiffness are relatively constant within a given shock absorber and spring combination) or are adjustable through electromechanical means (such as driver-controlled ride-adjustment componentry). Neither of these approaches are acceptable for vehicles configured for racing, where slight differences in the suspension setup can mean the difference between winning and losing. The conditions of race tracks and race cars, both of which can be dependent upon environmental conditions, and can change over the course of a race, necessitate that quick, precise spring perch adjustments be made within a limited amount of time, most notably during practice or a pit stop during the race. The relatively fixed nature of the conventional passenger vehicle shock absorber system is such that adjustment can only be achieved when the vehicle is removed from service, which is incompatible with the fast-paced adjustments necessary in racing situations. Furthermore, due to the weight-sensitive nature of racing vehicles, any adjustable features must be incorporated without introducing significant vehicular weight or complexity. The inclusion of the aforementioned driver-controlled ride-adjustment componentry, which may include pneumatic or hydraulic actuators, conduit or the like, as well as electrical or mechanical power sources to effect such adjustment, is anathema to keeping such weight and complexity of the vehicle low.

To overcome these shortcomings of passenger vehicle shock absorber systems, racing vehicles are often equipped with adjustable coil-over shock absorber systems, where a spring perch adjustment nut (also known as a shock absorber adjustment nut or an adjustment nut) is threaded onto a portion (typically the shock absorber body) of the coil-over shock assembly. By rotating the nut, the mechanic can adjust the vehicle's ride height and weight jacking, the latter to increase or decrease suspension load on a particular wheel, in response to the driver's feel and needs for the racing surface. Adjustment is effected by placing a wrench, spanner or related tool over the nut and turning it in the appropriate direction. In many vehicles, particularly race cars, the shock absorber system is relatively inaccessible, being surrounded by other vehicle components. In such circumstances, the handle of the tool that is used to improve leverage becomes a hindrance, as it can become difficult to maneuver it past other vehicle componentry to get to the spring perch adjustment nut. In addition, once the tool is secured to the nut, the limited amount of space makes it difficult to move the tool sufficiently to re-engage the tool in the next index position to effect nut rotation. Furthermore, if the tool is misaligned with the adjustable nut and a torque is applied to the nut, the nut (which is typically of a softer material than the tool) is susceptible to damage.

Accordingly, there exists a need for a coil-over shock absorber adjustment system that can fit into relatively tight spaces to enable adjustment to shock absorber systems without having to remove the vehicle from service. Moreover, there is a need for a coil-over shock absorber adjustment system that can accommodate different sizes and configurations of spring perch adjustment nuts. There also exists a need for a coil-over shock absorber adjustment system that is easy to operate, retains portability and is resistant to wear over prolonged use.

### SUMMARY OF THE INVENTION

The present invention satisfies these needs by providing a device that is very rugged and durable in its construction. According to a first aspect of the present invention, a shock absorber adjusting device includes a handle with a head coupled to it. The head defines an engaging member that is configured to couple to a spring perch adjustment nut to facilitate rotation of the nut upon application of a torque to the nut from the device. Additionally, the device includes a reversible ratcheting mechanism cooperative with the engaging member. Such a ratcheting mechanism facilitates rotation of the head to engage the nut without removal and reinstallation of the head.

Optionally, the head may be of an open-ended configuration to allow placement of the device over the shock absorber to facilitate engagement of the device and the nut. In addition, at least a portion of the engaging member defines a curvilinear race. Pawls on the ratcheting mechanism form at least a portion of the race, thereby allowing engagement with complementary teeth on a nut or an adapter. For example, the device may further include an adapter ring configured to fit within the engaging member, where a plurality of teeth disposed around the outer periphery of the adapter ring can engage the pawls of the ratcheting mechanism to make the adapter ring rotatably responsive to rotation of the head. In one form, the adapter ring is split to facilitate its placement around the shock absorber body without having to remove shock absorber componentry. In a more particular form, the adapter ring can be split into two or more complementary parts that when assembled make up the ring-like shape of the whole. One way the parts can be made complementary is to have them formed of interlocking pieces, while another is to have a generally straight, planar interface. Appropriate joining hardware can be used to keep the split portions of the adapter ring together. The adapter ring may further include a plurality of detents projecting from one of the axial ends to give the ring a castellated shape. The detents are arranged in a predetermined pattern (such as equal spacing around the ring's periphery) so that they can fit into corresponding slots in the spring perch adjustment nut. This keyed connection promotes rotational responsiveness between the nut and the adapter ring. Furthermore, at least a portion of the plurality of detents define an aperture in them for accepting a securing pin that can in turn be used to lock the ring and nut together. The device may further comprise a hinge disposed between the head and the handle to facilitate pivotal movement between them, thereby promoting both placement and rotation of the device in tight spaces. The device is configured such that the ratcheting rotation is up to six degrees, with more particular spacing of the teeth such that the ratcheting rotation is approximately four degrees. Such a configuration could be achieved with ninety teeth disposed on either the nut or the optional adapter ring. In the present context, a ratcheting rotation is that angle subtended every time a pawl on the ratcheting mechanism moves past a corresponding tooth on either an adapter ring or the shock absorber adjustment nut.

According to another aspect of the invention, a shock absorber adjusting wrench includes a handle with a proximal end and a distal end, a head coupled to the distal end, a hinge disposed between the handle and the head to facilitate pivotal movement between them, and a ratcheting mechanism. As before, the head includes an engaging member that is configured to couple to a shock absorber adjustment nut to facilitate reversible rotation of the nut. The head also includes a closed end disposed adjacent the distal end of the handle and an open end disposed away from the closed end. The open end is configured to allow placement of the wrench over the shock absorber body to facilitate coupling of the engaging member to the nut. Also as before, the ratcheting mechanism is cooperative with the engaging member such that upon ratcheting rotation of the wrench about the nut (which is preferably threaded along a substantially longitudinal axis of the shock absorber), the nut can be rotated, thereby effecting loosening or tightening adjustment of at least one of the shock absorber or a spring coupled to the shock absorber.

According to yet another aspect of the invention, a shock absorber adjusting assembly is disclosed. The assembly includes a wrench and a nut. The wrench includes a handle, a nut-engaging member coupled to the handle and a ratcheting mechanism cooperative with the nut-engaging member. The nut is disposable on a shock absorber to facilitate adjustment of at least one of the coiled spring or the shock absorber and is configured to cooperate with the nut-engaging member. Optionally, the nut-engaging member includes a closed end disposed adjacent the handle and an open end disposed away from the closed end, where the open end is configured to allow placement of the nut-engaging member over the shock absorber to facilitate engagement of the nut-engaging member and the shock absorber adjustment nut. As discussed in conjunction with the previous aspects, at least a portion of the nut-engaging member defines a race such that pawls on the ratcheting mechanism form at least a portion of the race. The nut may include a plurality of teeth disposed around its outer surface such that they can engage the pawls to make the nut rotatably responsive to rotation of the wrench. Since the nut generally stays on the shock absorber, there is an incentive to reduce its weight (especially for racing applications). Accordingly, the nut can be made from a lightweight material that is an alternate to steel, such as aluminum or an aluminum alloy, or even a nonmetal. To provide a hard, corrosion-resistant surface, the nut may include a conversion coating, plating or other protective coating. For example, the nut may be anodized. One or more bores can be formed in the nut, while a securing member (such as a screw) can be threaded into the bore to inhibit the tendency of the nut to come loose due to vibration or the like. A block can be inserted into the bore prior to the securing member. As with the previous aspects, a hinge may be disposed between the nut-engaging member and the handle to facilitate pivotal movement between them.

According to still another aspect of the invention, a shock absorber adjusting assembly is disclosed. The assembly includes a wrench and an adapter ring. The wrench includes a handle, an engaging member coupled to the handle, and a ratcheting mechanism cooperative with the engaging member. The adapter ring can be used to couple the engaging member to a nut disposed on a shock absorber, and further can be removably disposed in the engaging member. Optionally, the engaging member includes a closed end disposed adjacent the handle and an open end disposed away from the closed end. The open end is configured to allow placement of the engaging member and the adapter ring over the shock absorber to facilitate engagement of the adapter ring and the nut. At least a portion of the engaging member may define a race such that pawls making up the ratcheting mechanism form at least a portion of such race. The adapter ring may include a plurality of teeth disposed peripherally around its outer surface. As previously discussed, the teeth of the adapter ring can engage the pawls to make the adapter ring rotatably responsive to rotation of the wrench. Also as previously discussed, numerous detents projecting from the adapter ring can be included. These detents are substantially alignable with corresponding slots in the nut such that the nut is rotatably responsive to rotation of the adapter ring. Moreover, at least a portion of the plurality of detents define an aperture therein. A securing pin, bolt or screw may also be included, where the pin, bolt or screw is disposable in the aperture and the nut, thereby preserving the rotatable relationship between the adapter ring and the nut. As discussed in conjunction with at least one of the previous aspects, the teeth on the outer surface of the adapter ring can be spaced a predetermined distance apart, such as substantially four degrees apart. The shock absorber adjusting assembly may further include at least one thrust bearing disposed against the spring of the shock absorber. In one form, the thrust bearing acts as an axial spacer between the springs of the shock absorber and the nut. For example, the thrust bearing can be placed between the spring perch adjustment nut and the spring to facilitate spring end misalignment, reduce turning friction, or both. In circumstances where a dedicated shock absorber spring perch adjustment nut is used instead of an adapter ring, the thrust bearing can be placed between the nut and the spring, or can be incorporated as an integral unit.

According to another aspect of the invention, a method of using a shock absorber adjusting device is disclosed. The method includes arranging a shock absorber system to include a shock absorber adjustment nut that is configured to facilitate adjustment of at least one of a spring or shock absorber making up the shock absorber system, configuring a shock absorber adjusting device to comprise a handle, head and ratcheting mechanism as previously discussed, coupling the device to the shock absorber adjustment nut and ratcheting the device to effect an adjustment to the shock absorber adjustment nut. Optionally, an adapter ring can be placed between the shock absorber adjustment nut and the engaging member to facilitate coupling between them, as can one or more thrust bearings. The device can be further configured to include a hinge disposed between the head and the handle to facilitate pivotal movement between them. In yet another option, the head of the device can be configured to include a closed end disposed adjacent a distal end of the handle and an open end disposed away from the closed end, the open end configured to allow placement of the device over the shock absorber system to facilitate engagement of the device and the shock absorber adjustment nut.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals and in which:

FIG. 1 illustrates a coil-over shock system and an adjustment device according to the prior art;

FIG. 2 illustrates a shock absorber adjusting device according to an aspect of the present invention;

FIG. 3A illustrates the wrench portion of the device of FIG. 2 in a first non-articulated position;

FIG. 3B illustrates the wrench of FIG. 2 in a second, articulated, position;

FIG. 4A illustrates a perspective view of the underside of the wrench of FIG. 2;

FIG. 4B illustrates the wrench of FIG. 4A engaging a shock absorber system;

FIG. 5A illustrates a illustrates another perspective view of the wrench of FIG. 2;

FIG. 5B illustrates the wrench of FIG. 5A engaging a shock absorber system;

FIG. 6 illustrates adjustment of a shock absorber system while the system is mounted to a vehicular suspension system;

FIG. 7 illustrates one embodiment of a shock absorber adjustment nut that can be used with the present invention;

FIG. 8A illustrates another embodiment of a shock absorber adjustment nut that can be used as part of the present invention; and

FIG. 8B illustrates how the shock absorber adjustment nut of FIG. 8A can be secured using a securing member.

### DETAILED DESCRIPTION OF THE PREFERRED EMBODIMENTS

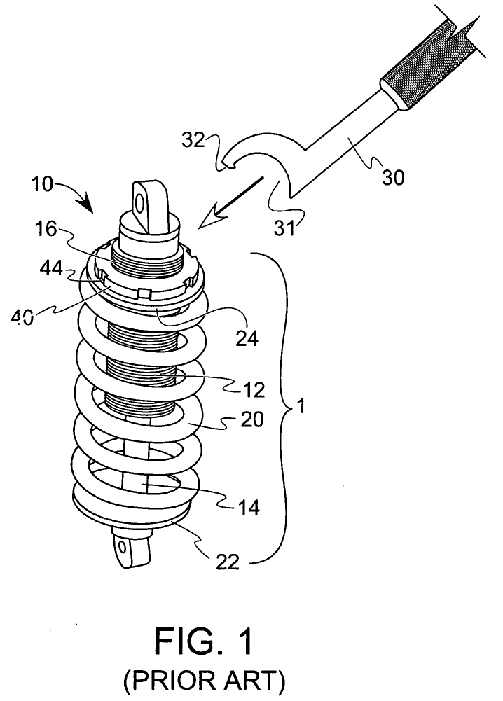

Referring first to FIG. 1, a shock absorber system 1 and a spanner 30 according to the prior art is disclosed. In particular, a coil-over-shock system is shown, where a shock absorber 10 has a coiled spring 20 wound around it. Shock absorber 10 includes a body 12 and a piston rod 14 with an internal piston (not shown) disposed inside body 12. The body 12 of piston 10 is threaded with threads 16. A fluid port (not shown) is also included to allow the insertion and removal of pressurized (typically inert) shock absorber gas. Spring perches 22, 24 are placed at opposing axial ends of the spring 20, where lower spring perch 22 is secured to the piston rod 14 and the upper spring perch 24 is secured on one side to the shock absorber body 12 and on the other to a shock absorber adjustment nut 40 the latter of which is threadably engaged with threads 16 of the shock absorber body 12 to keep the spring 20 compressed at a preferred level. Spanner 30 with nut-engaging portion 31 (including pawl 32) is used to either tighten or loosen the shock absorber adjustment nut 40. The shock absorber adjustment nut 40 includes on a radially-outward portion of its outer surface a plurality of periodically spaced slots 44 (typically every sixty degrees) on the outer periphery. The slots 44 are configured to accept a pawl 32 on spanner 30, thereby facilitating tightening or loosening of shock absorber adjustment nut 40 and the spring 20 and shock absorber 10 restrained thereby. The spacing between pawl 32 and the remainder of the nut-engaging portion 31 is fixed, and both of these are fixed relative to the fixed handle of spanner 30. By having the slots 44 spaced every sixty degrees as shown, the spanner 30 must cover one-sixth of a complete rotation before the user can reach the next engagement position. While this may not be problematic in an easily-accessible environment, it can become difficult or impossible in confined spaces (such as the region around an automotive shock absorber system) where room to rotate the nut-engaging portion 31 of the spanner 30 is limited.

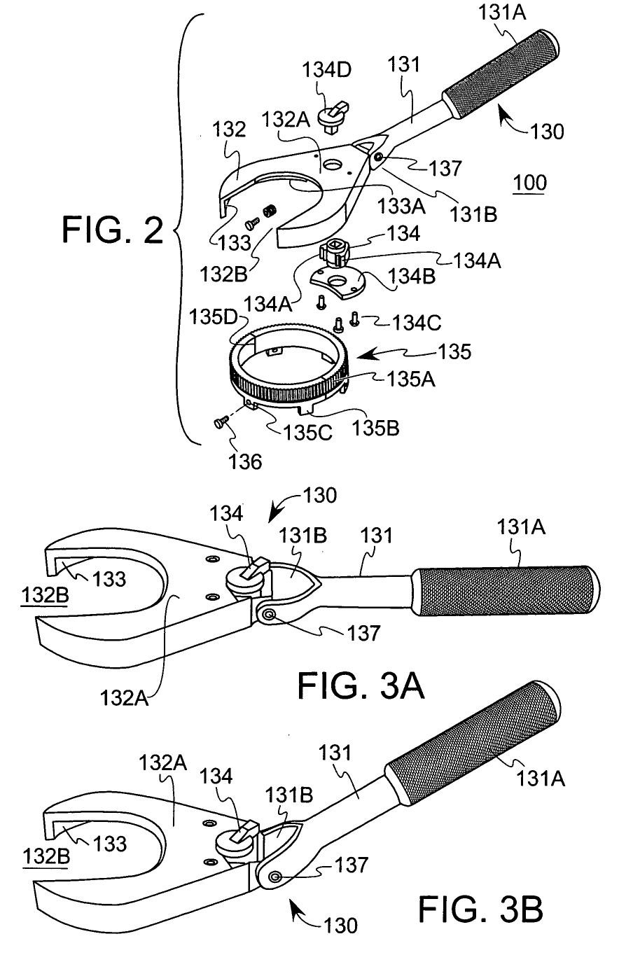

Referring next to FIGS. 2, 7, 8A and 8B, a shock absorber adjusting device 100 according to an aspect of the present invention is shown. The device 100 includes a wrench 130 with a handle 131 with a proximal end 131A and a distal end 131B. The wrench 130 also has a head 132 coupled to the distal end 131B of handle 131, and defines an engaging member 133 that can be used to couple to adapter ring 135 or directly to the shock absorber adjustment nut 140 shown in FIG. 8A. Ratcheting mechanism 134 fits within head 132, being secured thereto by a cover 134B and screws 134C. Ratcheting mechanism 134 is reversible by switch 134D, which pivots ratcheting mechanism 134 to allow one of two sets of pawls 134A to engage complementary teeth 135A, 140A on adapter ring 135 or shock absorber adjustment nut 140, respectively. In a preferred (although not necessary) embodiment, there are ninety teeth 135A on adapter ring 135 or shock absorber adjustment nut 140, thus giving a ratcheting angle of four degrees per pawl click. Rather than have the entire head 132 define a closed surface, the open configuration permits easier access to either shock absorber adjustment nut 40, 140, especially in situations where the size of the head does not permit an aperture that would otherwise be defined within the engaging member to be placed over the shock absorber. The hinge 137 promotes additional wrench 130 adjustability, which allows the user additional degrees of freedom when trying to maneuver the wrench 130 in tight spaces.

Referring with particularity to FIGS. 8A and 8B, device 100 may be configured such that the separate adapter ring 135 of FIG. 2 is not needed. In this embodiment, shock absorber adjustment nut 140 can be placed on threads 16 of shock absorber 10 such that it directly engages with the engaging member 133 of wrench 130. Nut 140 defines a continuous arrangement of teeth 140A that are sized to accommodate the pawls 134A disposed on the race 133A of engaging member 133. Nut 140 includes threads 140B that can engage complementary threads 16 on the shock absorber 10. Nut 140, which remains attached to the shock absorber system 1, will out of necessity be of a size to properly engage shock absorber 10. Accordingly, its outer dimension may vary depending on the vehicle and shock absorber system 1 to which it is coupled. To accommodate this, the engaging member 133 of wrench 130 may be made in corresponding sizes to accept nuts of differing sizes. In this way, a particular wrench 130 will always be of appropriate size for a nut 140 to which it corresponds. Nut 140 may form a part of a shock absorber adjusting assembly, in which it can be used as an aftermarket replacement for factory-equipped shock absorber adjustment nuts, or it may be part of the factory-equipped shock absorber system. In either event, the teeth 140A and outer dimensions are such that the nut 140 may directly engage the engaging member 133 of wrench 130. Referring with particularity to FIG. 8B, nut 140 may include one or more bores 140C angularly disposed in the nut 140 such that the nut 140 can accept a securing member 136 into the bore 140C, thereby providing enhanced securing of nut 140 to the shock absorber body (not presently shown). Securing member 136 (now preferably in the form of a screw, such as an alien screw) may further include a block 136A (made of a relatively compliant material, such as nylon) that can minimize the risk of damaging threads on the shock absorber body in the event the securing member 136 is over-tightened. In addition, by virtue of its relative soft nature, the block 136A can conform to the shape of the shock absorber threads as it is forced against them. The presence of the securing member 136 holding the nut 140 helps prevent the nut 140 from being shaken loose due to vibration and related loads on the shock absorber system.

Referring with particularity to FIG. 7 in conjunction with FIG. 2, while device 100 may be configured to engage directly with nut 140, as discussed above, it may also include adapter ring 135 in configurations where nut 40 is used to secure the spring perch. Unlike the nut 140 shown in FIG. 8A, nut 40 has keyed slots 44 formed about its periphery to engage detents 135B on adapter ring 135. As with threads 140B of nut 140, nut 40 includes threads 46 that can engage complementary threads 16 on the shock absorber 10. It will be understood that the outer diameter of nut 140 and nut 40 are compatible. Adapter ring 135 is sized to fit within engaging member 133 such that it can rotate along curvilinear race 133A formed within engaging member 133. Downwardly-projecting detents 135B are used to engage reciprocal slots 44 formed in shock absorber adjustment nut 40. In order to keep commonality with many of the nuts presently on the market, the detents 135B total six in number, and are spaced sixty degrees apart, giving the adapter ring 135 as crown or castellated structure. The adapter ring 135 fits within engaging member 133 such that it will stay in place when being placed onto the shock absorber adjustment nut 40, but loose enough that they will be easy to separate by hand. The adapter ring 135 can be defined by either a continuous, one-piece construction, or a multi-piece split construction with lines of separation 135D between opposing halves as shown. This split construction allows the complementary halves to be assembled together once they have been put in place onto shock absorber adjustment nut 40. Apertures 135C can be placed in detents 135B and sized to accept a securing member 136 (which may be in the form of a pin, bolt or screw) such that adapter ring 135 can be at least temporarily affixed to shock absorber adjustment nut 40. It will be appreciated by those skilled in the art that lines of separation 135D can form a simple divide or a more intricate interlocking fit.

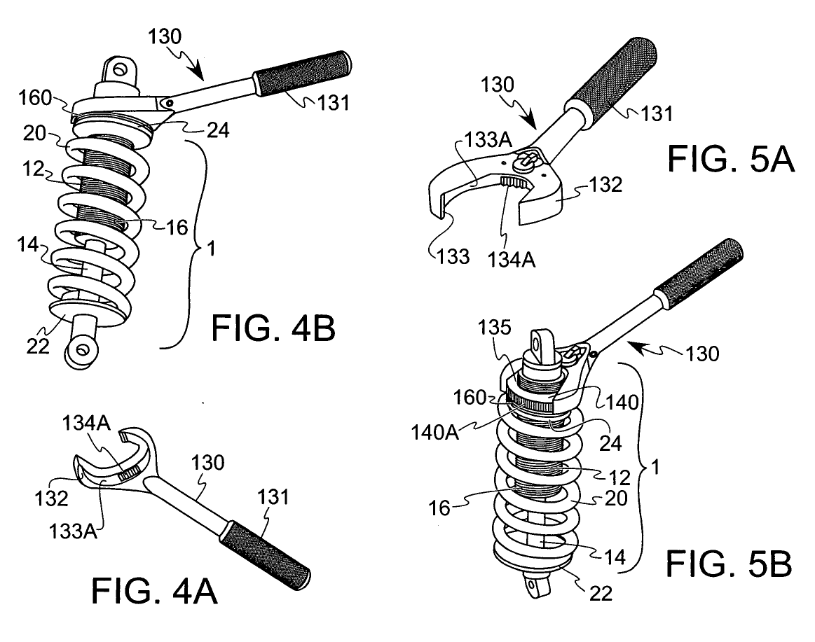

Referring next to FIGS. 4A, 4B, 5A and 5B, lower and upper views of the coupling of wrench 130 to a shock absorber system 1 to effect adjustment of the system is shown. Referring with particularity to FIG. 4A, the shape of race 133A and the position of pawls 134A (both within head 132) are shown. As shown in the figure, a significant portion of race 133A defines a curvilinear path to form a relatively tight fit with the cylindrical outer dimension of either shock absorber adjustment nut 140 or adapter ring 135. Referring with particularity to FIG. 4B, the wrench 130 is shown in an engagement position, where a shock absorber adjustment nut (for example, one of nuts 40 or 140 from FIGS. 7, 8A and 8B) is situated above spring perch 24, but hidden in the present view. Washer-like bearings 160 may be placed between the spring perch 24 and the shock absorber adjusting nut 40, 140. Referring with particularity to FIG. 5A, the partial projection of pawls 134A into the race 133A can be seen; such projection helps to ensure fit between the wrench 130 and either shock absorber adjustment nut 140 or adapter ring 135. As can be seen in both FIGS. 4A and 5A, the open-ended construction of the engaging portion 133 promotes a secure fit between head 132 and the corresponding part on the shock absorber system 1, especially in situations where interference from connectors or other ancillary components is a possibility. Referring with particularity to FIG. 5B, the wrench 130 is shown in an engagement position with shock absorber adjustment nut 140, where a portion of teeth 140A are visible through the open end of engaging member 133. As previously discussed, if nut 40 from FIG. 7 is used, then adapter ring 135 (not presently shown) would couple wrench 130 to nut 40.

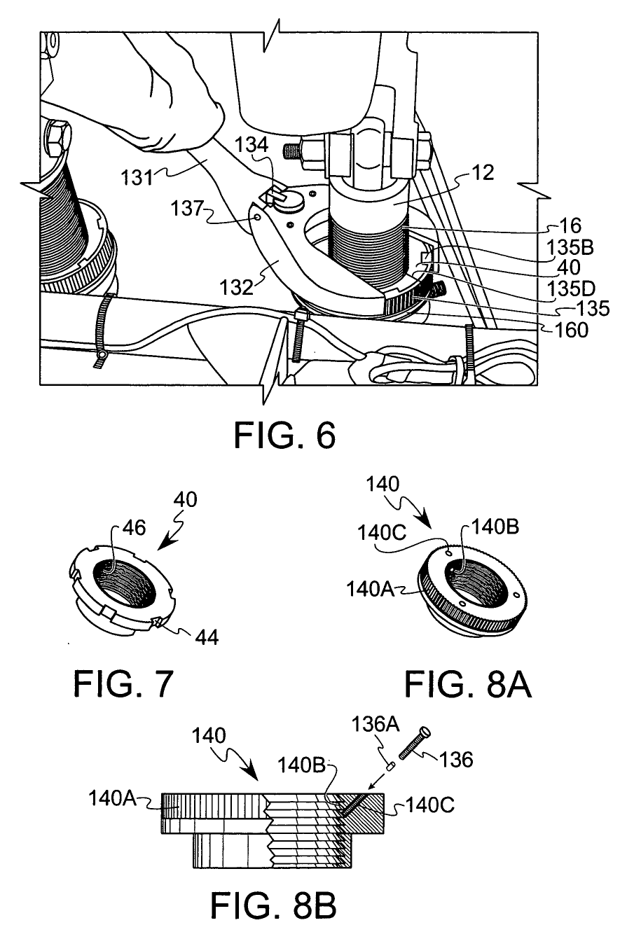

Referring next to FIG. 6, application of one embodiment of the device of the present invention in the relatively cramped confines of an automotive application is shown. In the present figure, the variant with adapter ring 135 is shown. The pivoting relationship between the handle 131 and head 132, made possible by hinge 137, facilitates insertion of wrench 130 through tortuous paths to enable engagement with the nut 40 of the shock absorber system. While the device 100 disclosed is particularly applicable to shock absorber systems used in vehicular racing, it will be appreciated by those skilled in the art that it is not limited to racing applications, as any situation requiring adjustment of such a nut would benefit equally from use with the disclosed device.

Having described the invention in detail and by reference to preferred embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A shock absorber adjusting device comprising:
a handle with a proximal end and a distal end;
a head coupled to said distal end and defining an engaging member that is configured to couple to a shock absorber adjustment nut to facilitate rotation thereof; and
a ratcheting mechanism cooperative with said engaging member such that upon ratcheting rotation of said device about a substantially longitudinal axis of said shock absorber, said shock absorber adjustment nut can be rotated.

2. The device of claim 1, wherein said head comprises:
a closed end disposed adjacent said distal end of said handle; and
an open end disposed away from said closed end, said open end configured to allow placement of said device over said shock absorber to facilitate engagement of said device and said shock absorber adjustment nut.

3. The device of claim 2, wherein at least a portion of said engaging member defines a curvilinear race with pawls making up said ratcheting mechanism forming at least a portion of said race.

4. The device of claim 1, further comprising an adapter ring configured to fit within said engaging member, said adapter ring comprising a plurality of teeth disposed around the outer periphery thereof, said adapter ring teeth configured to engage said pawls to make said adapter ring rotatably responsive to rotation of said head.

5. The device of claim 4, wherein said adapter ring comprises a plurality of complementary parts configured to be arranged together to define said ring.

6. The device of claim 4, further comprising a plurality of detents projecting from said adapter ring to define a castellated shape thereby, said detents configured to be substantially aligned with corresponding slots in said shock absorber adjustment nut such that said shock absorber nut is rotatably responsive to said adapter ring.

7. The device of claim 6, wherein at least a portion of said plurality of detents define an aperture therein.

8. The device of claim 7, further comprising a securing pin disposable in said detent aperture.

9. The device of claim 1, further comprising a hinge disposed between said head and said handle to facilitate pivotal movement therebetween.

10. The device of claim 1, wherein said device is configured such that an angle subtended by said ratcheting rotation is up to six degrees.

11. The device of claim 10, wherein said angle subtended by said ratcheting rotation is approximately four degrees.

12. A shock absorber adjusting wrench comprising:
a handle with a proximal end and a distal end;
a head coupled to said distal end, said head defining an engaging member that is configured to couple to a shock absorber adjustment nut to facilitate rotation thereof, said head comprising:
a closed end disposed adjacent said distal end of said handle; and
an open end disposed away from said closed end, said open end configured to allow placement of said wrench over said shock absorber to facilitate coupling of said engaging member to said shock absorber adjustment nut;
a hinge disposed between said handle and said head to facilitate pivotal movement therebetween; and
a ratcheting mechanism cooperative with said engaging member such that upon ratcheting rotation of said wrench about said shock absorber adjustment nut threaded along a substantially longitudinal axis of said shock absorber, at least one of said shock absorber or a spring coupled thereto can be adjusted.

13. A shock absorber adjusting assembly comprising:
a wrench comprising:
a handle;
a nut-engaging member coupled to said handle; and
a ratcheting mechanism cooperative with said nut-engaging member; and
a nut disposable on a shock absorber and configured to cooperate with said nut-engaging member to facilitate adjustment of at least one of said shock absorber or a spring coupled thereto.

14. The shock absorber adjusting assembly of claim 13, wherein said nut-engaging member comprises:
a closed end disposed adjacent said handle; and
an open end disposed away from said closed end, said open end configured to allow placement of said nut-engaging member over said shock absorber to facilitate engagement of said nut-engaging member and said shock absorber adjustment nut.

15. The shock absorber adjusting assembly of claim 14, wherein at least a portion of said nut-engaging member defines a race with pawls making up said ratcheting mechanism forming at least a portion of said race.

16. The shock absorber adjusting assembly of claim 15, wherein said nut comprises a plurality of teeth disposed around its outer surface, said teeth on said outer surface configured to engage said pawls to make said nut rotatably responsive to rotation of said wrench.

17. The shock absorber adjusting assembly of claim 15, further comprising an adapter ring configured to fit between said nut-engaging member and said nut, said adapter ring comprising a plurality of teeth disposed around the outer periphery thereof, said adapter ring teeth configured to engage said pawls to make said adapter ring responsive to rotation of said head.

18. The shock absorber adjusting assembly of claim 17, further comprising at least one bore formed in said nut, and a securing member disposable in said bore.

19. The shock absorber adjusting assembly of claim 18, further comprising a block disposable in said bore adjacent said securing member.

20. The shock absorber adjusting assembly of claim 13, wherein said nut is made from a material having a lower density than steel.

21. The shock absorber adjusting assembly of claim 20, wherein material is a lightweight metal.

22. The shock absorber adjusting assembly of claim 21, wherein said lightweight metal is aluminum or an alloy thereof.

23. The shock absorber adjusting assembly of claim 22, wherein said aluminum or alloys thereof is anodized.

24. The shock absorber adjusting assembly of claim 17, wherein said nut further comprises a protective layer formed on the surface thereof.

25. The shock absorber adjusting assembly of claim 13, further comprising a hinge disposed between said nut-engaging member and said handle to facilitate pivotal movement therebetween.

26. A shock absorber adjusting assembly comprising:
a wrench comprising:
a handle;
an engaging member coupled to said handle; and
a ratcheting mechanism cooperative with said engaging member; and
an adapter ring configured to couple said engaging member to a nut disposed on a shock absorber, said adapter ring configured to be removably disposed in said engaging member.

27. The shock absorber adjusting assembly of claim 26, wherein said engaging member comprises:
a closed end disposed adjacent said handle; and
an open end disposed away from said closed end, said open end configured to allow placement of said engaging member and said adapter ring over said shock absorber to facilitate engagement of said adapter ring and said nut.

28. The shock absorber adjusting assembly of claim 27, wherein at least a portion of said engaging member defines a race such that pawls making up said ratcheting mechanism form at least a portion of said race.

29. The shock absorber adjusting assembly of claim 28, wherein said adapter ring comprises a plurality of teeth disposed around the periphery thereof, said teeth on said outer surface configured to engage said pawls to make said adapter ring rotatably responsive to rotation of said wrench.

30. The shock absorber adjusting assembly of claim 29, further comprising a plurality of detents projecting from said adapter ring to define a castellated shape thereby, said detents configured to be substantially alignable with corresponding slots in said nut such that said nut is rotatably responsive to said adapter ring.

31. The shock absorber adjusting assembly of claim 30, wherein at least a portion of said plurality of detents define an aperture therein.

32. The shock absorber adjusting assembly of claim 31, further comprising a securing pin disposable in said aperture and into said nut, thereby preserving the rotatable relationship between said adapter ring and said nut.

33. The shock absorber adjusting assembly of claim 29, wherein said teeth on said outer surface are spaced substantially four degrees apart.

34. The shock absorber adjusting assembly of claim 26, further comprising at least one thrust bearing configured to be disposed against at least one of said nut or said adapter ring.

35. A method of using a shock absorber adjusting device, said method comprising:
arranging a shock absorber system to include a shock absorber adjustment nut that is configured to facilitate adjustment of at least one of a spring or shock absorber making up said shock absorber system;
configuring a shock absorber adjusting device to comprise:
a handle with a proximal end and a distal end;
a head coupled to said distal end and defining an engaging member that is configured to couple to said shock absorber adjustment nut to facilitate rotation thereof; and
a ratcheting mechanism cooperative with said engaging member such that upon ratcheting rotation of said device about said shock absorber adjustment nut threaded along a substantially longitudinal axis of said shock absorber, at least one of said shock absorber or said spring coupled thereto can be adjusted;
coupling said device to said shock absorber adjustment nut; and
ratcheting said device to effect an adjustment to said shock absorber adjustment nut.

36. The method of claim 35, further comprising placing an adapter ring between said shock absorber adjustment nut and said engaging member to facilitate said coupling therebetween.

37. The method according to claim 35, further comprising placing at least one thrust bearing against at least one of said adapter ring or said shock absorber adjustment nut.

38. The method of claim 35, further comprising configuring said device to include a hinge disposed between said head and said handle to facilitate pivotal movement therebetween.

39. The method of claim 35, further comprising configuring said head of said device to include:
a closed end disposed adjacent said distal end of said handle; and
an open end disposed away from said closed end, said open end configured to allow placement of said device over said shock absorber system to facilitate engagement of said device and said shock absorber adjustment nut.
